(19) United States
(12) Patent Application Publication
(10) Pub. No.: US 2022/0101312 A1
(43) Pub. Date: Mar. 31, 2022

(54) Creation and use of controlled, and limited digital fantasy image token to enable digital wealth creation and growth-DFIT

(71) Applicant: Edward Antheal Baxter, Rockwall, TX (US)

(72) Inventor: Edward Antheal Baxter, Rockwall, TX (US)

(21) Appl. No.: 17/395,733

(22) Filed: Aug. 6, 2021

Related U.S. Application Data
(60) Provisional application No. 63/084,668, filed on Sep. 29, 2020.

(51) Int. Cl. G06Q 20/38; G06Q 30/02; G06Q 20/40; H04L 9/32

(52) U.S. Cl. CPC G06Q 20/389; G06Q 30/0283; H04L 2209/38; H04L 9/3213; G06Q 20/4014

(57) ABSTRACT

Public imagery for the purposes of promotion, there is a need to be efficient. Measuring the impact of using a particular image and accurately assessing the impact on consumer purchase behavior has unlimited value, and protecting those images is vital. Media companies have always desired to create desirable outcomes for their customers by measuring impact of endorsements or determining the optimal placement to impact sales and gains in market share for their client advisors. While there are market analytic groups that measure the post-launch impact of an endorsement, there are few if any methods that are able to assign a value to an image (endorsement) in real time and measure this value in real-time. The platform used here measures the pre-launch efficacy of these images and transforms digital followers of the owners of those personas into digital loyalists; capable of converting a lifetime of digital value creation into perpetual digital wealth for that persona holder. For celebrities, charities, universities, athletes, and public figures the platform described here represents a unique method for monetization of the digital value for those individuals or entities who have built significant followings.

Internet Celebrity (aka social media influencer)—is a celebrity who has acquired or developed their fame and notability through the internet. Many influencers have been recruited by companies for influencer marketing to advertise products to the followers on various social media outlets. This can be done in many areas including fashion, beauty products, video games, politics, music and entertainment. Many of these influencers have had challenges in assessing the value of their platforms. This disclosure presents an entertaining method for these persons to keep their likeness monetized for their own benefit (or their clients) rather than those who would co-opt that image and attempt to benefit for free.

Electronic Token (aka non-fungible token)—a secondary method to gain access to an electronically restricted resource. Traditionally these have been wireless keycards for use in opening a locked door. In more recent vernacular some tokens are cryptographic keys used to generate a digital signature. In another way these are random strings used as a surrogate or proxy for some other data. There is no direct mathematical relationship between the original value and the random token, so the original data cannot be determined from the token, therefore the original data cannot be determined from the token. The association between the token and the original value is maintained in a database, and there is no other way to connect the two.

Q score—A q score is a measurement of the familiarity and appeal of a brand, celebrity, company or entertainment product. The higher the Q score, the more highly regarded the item or person is. Q scores are primarily used by the advertising, marketing, media and public relations industries. The tokens and methods used in this disclosure could be used as a method to calculate a new variety of Q score.

Tokenization—The act of creating a token.

Encryption—Transforming data into an unreadable state. For any given value the process consistently produces the same result, and the process can only be reversed with special knowledge (or the key).

Hash—An irreversible mathematical function that scrambles data, producing a consistent and unique value. Used to create non-random tokens with some systems, but risks the original value being exposed through the mathematical relationship (if you can, generating a matching hash).

Encrypted Token—Data that has been encrypted, rather than replaced with a random value, using special encryption techniques that preserve format and data type. While these encrypted values are commonly used as tokens, each can be reversed into its original value, so this is technically encryption rather than tokenization.

Tokenization Process—The mathematical uniqueness of tokenized imagery offers the Company a competitive advantage to existing systems by creating “scarcity” within a given set of GFCI tokens for each influencer. We believe this to be a key to distributing to existing followers of each follower as this allows the Company to “test” their loyalty through their participation rates.

### FUNCTIONALITY

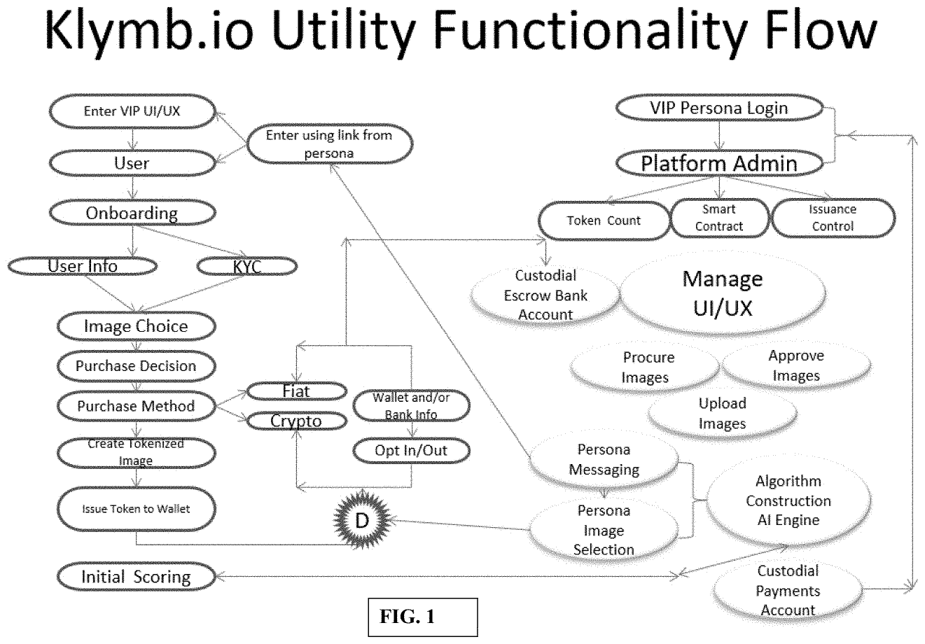

FIG. 1: Functional diagram of the digital entertainment token creation and distribution

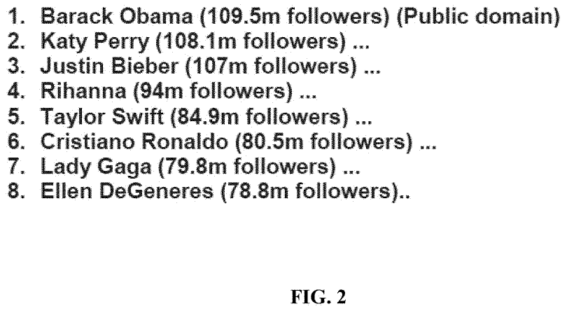

FIG. 2: A list of Twitter influencers and their number of followers.

### PURPOSE OF INVENTION

The ability to influence behavior of others is sought after and valuable. Someone (or an entity e.g. Disney or other large corporation) that can effectively do this is a highly sought after commodity. Creating a “digital following” for that brand can be influenced is invaluable, especially for digital brands. We refer to this process as lifetime digital value creation.

Many influencers have spent a great deal of time energy and money building their followers (or subscribers depending on the social media platform). The social media platform itself have benefited greatly from this free to the social media platform content provided by these personas and have proceeded to monetize that content via selling advertising revenue (sometimes with only a minor portion of that revenue going to the influencer, other times with no revenue going to the influencer, occasionally with a reasonable split between the two parties).

Adding a new dimension to this notion, this disclosed process represents a method of unleashing the power of each persona's loyal following to drive digital product distribution with their current and perspective followers. We refer to this process as “Lifetime digital wealth creation,” and recognize the infinite global distribution capabilities.

The process disclosed here enables this digital conversion of value by assigning it a measurable immutable digital utility token referred to as the Digital Fantasy Image Token (DFIT). This is done through a smart contract, each token is programmed with the unique characteristics of those likenesses inhabiting the platform, this creates a distinct extension of their individual brand.

In this particular process each participant has a vested interest in increasing their own value to enhance their image/brand, they are incentivized to leverage their social media followings as they “push” the acquisition, collection, via purchase off their DFIT. Inherent in pushing the distribution are increases in their DFIT Index score, which in turns fosters an increase in their off-platform endorsement value as it numerically distributes the intensity of their follower's loyalty.

In this process we use real time computational algorithms representing the value of that image. The process disclosed here unleashes the fans or followers to celebrate their preferences for their chosen influencer, and this fervor drives the numerical representation of that value.

For those influencers who image is their largest single asset, it marks the value of their brand, (what would Disney be without Mickey Mouse), this exhibits behavior that causes that influencer to desire to further advance that value, making that process of the utmost importance. Thanks to the rapid pace of information flow available on the internet the ability to digitally assess the value of the impact of an image in real time been paired with real time wealth creation associated with a particular persona. Today's technology not only allows it to happen but makes it extremely efficient, and rapid to do so.

This process identifies and measures and exploits the partners (influencers) to help drive the measurement characteristics and decision analytics behind the selection of particular favorites; their buying behaviors, and conversion habits and demographic fingerprints driving those choices. This is done all through a centralized virtual environment that will utilize continuous inputs of data from the current condition of the market.

Value drivers for this process include increased ease of sharing proceeds from the initial offerings of the DFIT, fees from transactions, future advertising and revenue from access to our analytic data. As the platform increases, we can use additional data from our own real time transfers of preferences to fuel our algorithms to score the image and use Artificial Intelligence to measure platform participant idiosyncrasies.

Additional benefit is also achieved through partnering with payment systems that allow the process to share in transaction fee revenue. These may be, but are not limited to, transactions conducted through bank accounts, online transaction companies such as but not limited to Apple Pay, and these transactions could take place with fiat currency, credit cards, and even digital currencies such as but not limited to Bitcoin.

As with any mass distribution platform this process is expected to foster behaviors that are both painless and entertaining. In other words, the process will be economically “painless,” and available in price increments that are open to a much larger group of participants.

This process, including the entertainment value, is open to all. The microtransaction based economy can be used as a basis for this process, however it is scalable to larger transactions as well.

FIG. 2: A list of Twitter influencers and their number of followers.

FIG. 2 gives a list of Twitter influencers and their number of followers. This list demonstrates a person's “compulsion to follow.” Each of these personas can derive benefit via the DFIT with the option for a percentage of the proceeds donated to the foundations or charities they support. This makes the disclosed process useful to become one of the most successful fundraising mechanisms ever created as it couples fund raising with a collectible entertainment token.

Evolution of the Process

A social media “influencer” is a person who has the power to sway the decision of their followers. As this is a new practice, influencer marketing is still evolving along with the social media platforms and audiences it relies on. Those in the field see a bright future, and this process would be beneficial to this new reality.

As social media platforms evolve and change, so will influencer marketing and this process which will enable influencers to capitalize on their platforms, this process remains platform agnostic.

This process will also aid greatly on influencers that focus on specifically narrowly defined audiences.

Why Does Influencer Marketing Work

Influencer marketing is about trust. It can be challenging get someone to click on a banner ad, following the recommendations of an influencer can feel more natural and organic, as it grows from a perceived relationship. Influencer marketing can be made more impactful than traditional methods of altering opinions and shaping purchasing decisions—particularly for younger audiences.

The challenge with influencer/image marketing is the need (which this process fulfills) for an effective scoring mechanism that will allow advertisers a real-time way to manage placements on micro-trending topics immediately, and persons with the goal of more precise ad placements when using those micro-demographic trends.

The process looks at the followers of major influencers, not we will look at usage in general. Since the widespread adoption of the internet we have seen the exponential growth in general and social media usage. Those followers and subscribers on these platforms represent the foundation of our value-add position through the percentage of conversions associated with those they follow. These platforms are especially attractive the “internet generation” they are the most likely to seek the “approval or endorsement,” of their purchases from their preferred influencer. This supports our thesis of the influencer converting their followers to purchasing the DFIT of their favorites. There are billions of users on social media as of 2020, which permeates all age brackets.

NCAA

Of specific interest and capability from this platform is the Collegiate athlete being able to monetize their popularity without exploitation (therefore protecting themselves in a traceable and verifiable method). This would be the transfer of billions of dollars in a traceable method.

Currently those athletes are treated with “kid” gloves but with current changes in the system they are now permitted to take advantage of their likeness rights. This methodology could keep these students safe from being taken advantage of.

Restrictions

The process can restrict purchases to any value chosen by the controlling software distributing the tokens. This can allow for students who have NCAA restrictions to add a “fuel guage” to income.

Gamification—the Real Process

Because of the digital nature of the instrument, a natural evolution of use of this token is in permitting fans/followers to enter prize contests that are based on the growth of the DFIT index number for their chosen token purchase persona.

In this scenario our gaming system allows purchases of their chosen DFIT instrument to “wager” on the incremental growth of the value of the persona in real time by predicting the percentage growth of those they hold in a similar method to collecting baseball cards or postage stamps. These “mini” contests can be held in real time during a sporting event and measure the immediate social media impact and scoring as play develops or with social media stars during the day, weekend, or during a special event.

As we establish each category of tokens, new verticals of influence capitalization are created without cannibalizing existing channels. In addition, it allows for the ability to diversity the platform revenue and train those using the tokenization engine to issue their own approvable tokens.

Each token created should expect to receive a DFIT rating measurement where appropriate to entice participants to hold multiple DFIT and other tokens and reward those collectors who “choose wisely” with sponsored prizes and discounts delivered in gamified fashion to improve “stickiness” and enhance the user experience.

Prizes can be any variety of objects including but not limited to: Vacations, computers, mobile accessories, clothes, shopping sprees, concert tickets, etc.

Each token placement will offer additional opportunities for revenue and referrals. As the product line grows, each token can be adorned with artwork approved by the issuer but adhering to decency rules designed to keep the platform G-rated. This can be done with artificial intelligence object/scene recognition.

With the establishment of the DFIT platform as a “destination” for those seeking to support their prospective influencer, regardless of the genre; the platform becomes the ultimate pipeline for marketing products and gathering information on how and by whom the products were chosen.

This type of gaming is important as it allows for expanding the user base outside of the direct contact with the DFIT used to measure the impact of the persona and royalties paid for their use. It also created a measurement market that currently does not exist. While certain terms, people, images, and personas may be “trending” the token allows what to do with that trending topic and how it impacts the influencers value.

Uses For Verification of Providence

In addition to contests, the smart contracts behind the DFIT and inherent trading platforms allow for the real time trading of “verified” instruments, weapons, clothing and training for gamers. The hashing of tools used by winning gamers have value in markets within the game itself. By fostering a real-time transaction platform that has those unique digital signatures used by winners of those tools used by them but that may also no longer be desired by them, and can now be sold in this new marketplace providing transactions and revenue for the gaming community.

This type of “verified providence” or unique verifiable asset represents the evolution of gaming transactions at every level by extending the social aspects of the game to all players all the time. At current count, there are 2.4 Billion active gamers globally representing a trading market several times the current marketplace.

What is claimed is:

A method comprising,
1) Enter the UI/UX
2) Create/Identify User
3) Onboarding if needed
4) Verify user information
5) User choice of image/token
6) Purchase decision
7) Purchase method chosen
8) Create Tokenized Image
9) Issue token to the wallet
10) Permit trading of tokens
11) Token count adjusted (available tokens down, tokens in wallet up)
12) Tokens must be scored
13) Algorithms/Artificial Intelligence verifies/resets value of token in real time.
